(19) United States
(12) Patent Application Publication
(10) Pub. No.: US 2020/0282250 A1
(43) Pub. Date: Sep. 10, 2020

(54) APPARATUS TO TREAT HAZARDOUS WASTE AND METHOD TO TREAT HAZARDOUS WASTE USING SAID APPARATUS

(71) Applicant: ZION ING S.A.S., Pereira (CO)

(72) Inventors: Marcela Guzman Herrera, Pereira (CO); Javier Eduardo Hincapie Lenis, Pereira (CO); David Gustavo Lagarejo Lloreda, Pereira (CO)

(73) Assignee: ZION ING S.A.S., Pereira (CO)

(21) Appl. No.: 16/646,264

(22) PCT Filed: Sep. 11, 2018
(86) PCT No.: PCT/IB2018/056948

§ 371 Date: Mar. 11, 2020

(30) Foreign Application Priority Data
Sep. 12, 2017 (CO) NC2017/0009221

(51) Int. Cl. A62D 3/19; H05H 1/26; F23G 5/00; F23G 5/08; F23G 5/36; F23G 5/44

(52) U.S. Cl. CPC A62D 3/19; H05H 1/26; F23G 5/008; F23G 5/085; F23G 2204/201; F23G 5/444; F23G 5/446; F23G 2200/00; F23G 5/36

(57) ABSTRACT

The invention relates to an apparatus which comprises a pyrolytic plasma reactor (1) with: a conical head (8), on which are mounted: inlets (2, 3, 4); a first plasma torch (6); and first gas outlet (5); a cylindrical reaction chamber (9), under the head (8), and which comprises: a side wall (11) with a refractory covering (12); and a bottom (16), o with a decreasing cross-section, for receiving lavas; a base (10), for supporting the head (8) and the reaction chamber (9); and discharge means in the reaction chamber (9) and/or in the base (10) for discharging the lavas. By keeping the first torch (6) lit, the method comprises directing solid, liquid and gaseous hazardous waste towards the central portion of the plasma jet from the first torch (6), with no contact between the various types of hazardous waste. The dissociation conditions are improved by the invention.

### OBJECT OF THE INVENTION

The present invention may be included within the waste treatment sector, in particular the treatment of hazardous waste. More specifically, according to a first aspect, the object of the present invention is an apparatus for treating hazardous waste, and according to a second aspect, the object of the invention refers to a method for treating hazardous waste which employs the aforementioned apparatus.

### BACKGROUND OF THE INVENTION

To treat hazardous waste, cylindrical reactors are usually used, which, with the help of plasma torches, produce temperatures highly enough to dissociate the molecules that make up the hazardous waste.

In particular, the application US2003167983A1 discloses a liquid waste feed system having a liquid inlet to a plasma torch based waste processing chamber, disposed between the primary plasma torch arrangement at the bottom end of the chamber and the top gas products outlet. The liquid inlet is positioned inside the chamber such that liquid waste flowing from the inlet into the chamber is directed at a high temperature zone of waste column, and the liquid inlet is typically associated with a hot gas jet means. The hot gas jet means providing the required high temperature zone may comprise one or more secondary torches configured to provide hot gas jets into the liquid discharge zone of the inlet. Alternatively, the hot gas jet may be provided by the primary plasma torches, in which case the liquid inlet is arranged within a predetermined area close to and above at least one of the primary plasma torches.

The application EP1607466A1 describes a process for continuously transforming waste obtained by means of plasma torches, preferably with transferred arc, powered with direct current in a first chamber separated by means of at least one dividing element, able to assure a high thermal conductivity, from a second chamber in which the waste is inserted, in such a way that the torches are not directly exposed to the chemical aggression of the gases formed during the destruction of the waste, and of the oxygen and/or air which may be injected or otherwise present.

Finally, the application WO2002096576A1 refers to a continuous transformation process for waste to obtain products with a controlled composition, carried out by chemical-physical reactions developed inside a plasma reactor, characterized in that it comprises the steps of: forming a plasma at atmospheric pressure; loading waste products to be processed, concomitantly with an oxidizing agent; load materials suitable for promoting the transfer of thermal energy and chemical-physical reactions that transform waste products; and extraction of controlled composition materials. The invention also relates to a reactor suitable for carrying out said process.

### DESCRIPTION OF THE INVENTION

The present invention provides an apparatus for treating hazardous waste, and a method for treating hazardous waste using said apparatus.

The apparatus for treating hazardous waste comprises a pyrolytic plasma reactor, which in turn comprises a head, a reaction chamber and a base.

The head has a conical shape, in which three separate inlets are mounted for solid, liquid and gaseous hazardous wastes. Likewise, the following are mounted on the head: a first torch to generate a plasma jet to dissociate the waste; and a gas outlet, to discharge gases generated by the dissociation.

The reaction chamber is situated under the head, and has hollow cylindrical shape, and comprises a side wall with refractory covering.

Likewise, the base supports the head and the reaction chamber, and comprises an upper face that serves as a background to the reaction chamber, to receive lavas formed in the dissociation.

The reactor also incorporates discharge means, located in the reaction chamber and/or in the base, to dislodge the lavas.

### DESCRIPTION OF THE DRAWINGS

To complement this description and to get a better understanding of the features of the invention, according to a preferred example of a practical embodiment thereof, as an integral part of this description it is herein attached a set of drawings where, for illustrative and non-limiting purposes, the following has been represented:

FIG. 1 shows a top perspective view of a reactor that is part of the apparatus for treating hazardous waste according to the present invention.

FIG. 2 shows a front view of the reactor.

FIG. 3 shows a bottom perspective view of the reactor.

FIG. 4 shows a view in axial longitudinal section of the reactor.

FIG. 5 shows a top perspective view in greater detail of the base of the reactor.

FIG. 6 shows a side view of the reactor.

FIG. 7 shows a plan view of the arrangement of the refractory covering.

### PREFERRED EMBODIMENT OF THE INVENTION

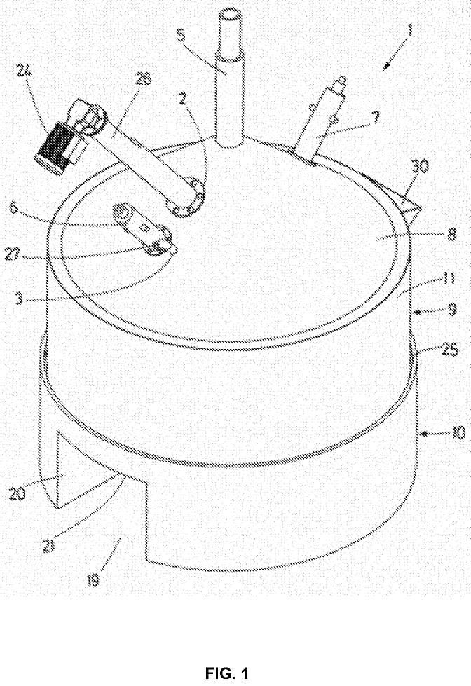

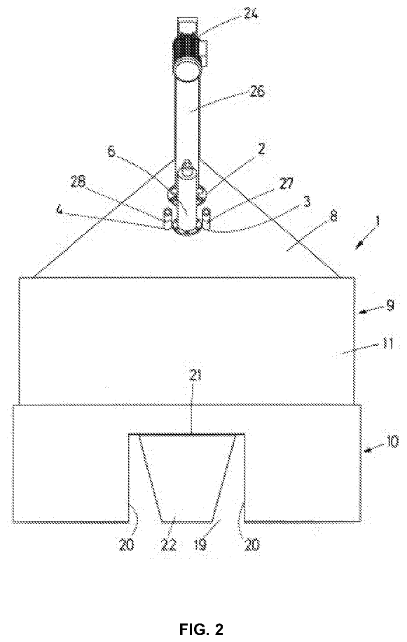

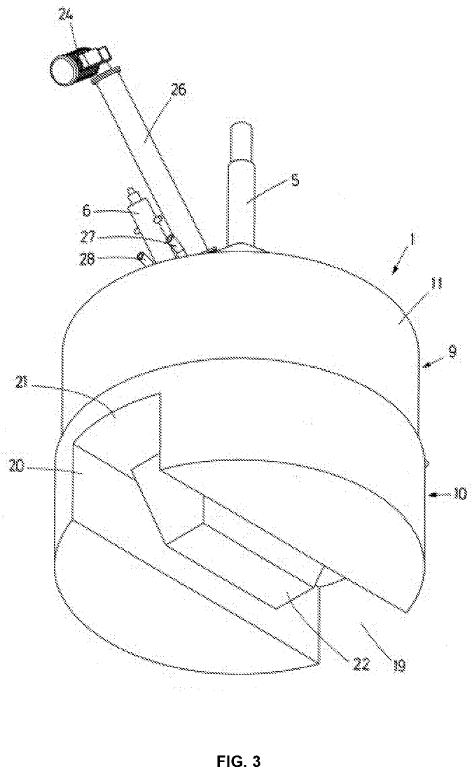

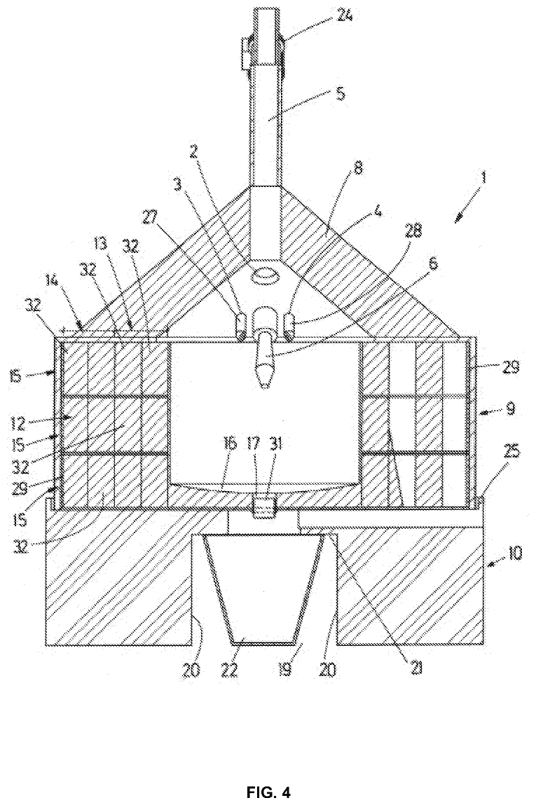

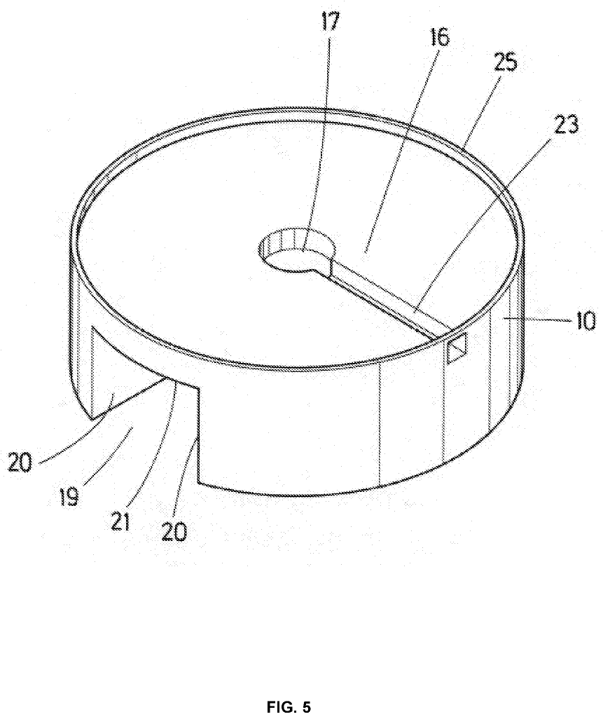

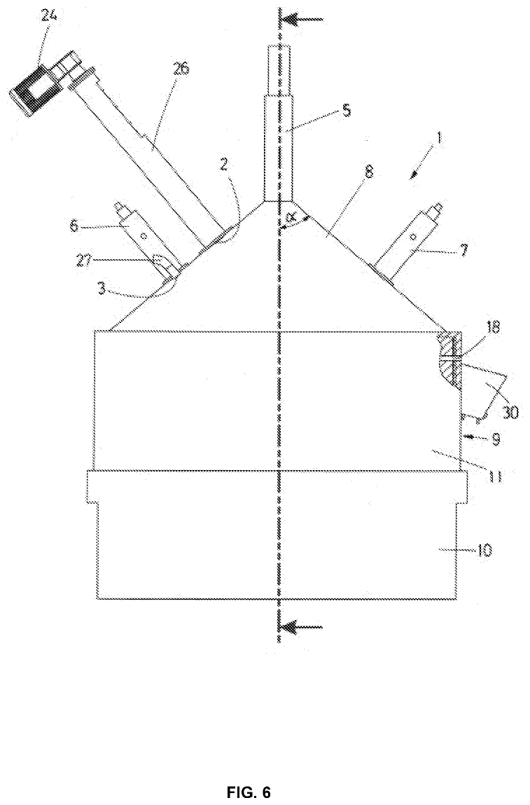

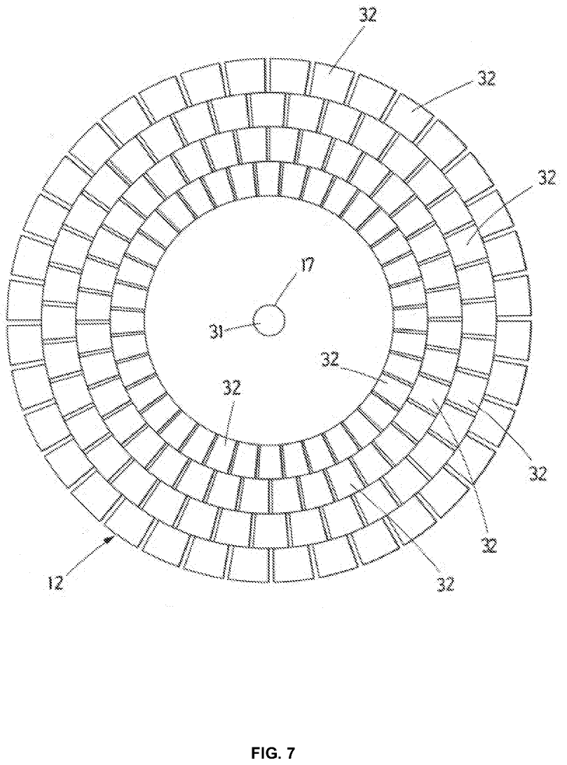

A detailed description of a preferred embodiment of the present invention is given below, with the aid of the attached FIGS. 1-7.

A first aspect of the present invention relates to an apparatus for treating hazardous waste. A second aspect relates to a method for treating hazardous waste using the aforementioned apparatus.

The apparatus of the invention comprises a pyrolytic plasma reactor (1) which is provided with three feed inputs (2, 3, 4), which allow the reactor (1) to be simultaneously fed, although separately and independently, with hazardous waste both in the solid and liquid state and also in the gaseous state. The reactor (1) also comprises a gas outlet (5), to discharge gases generated during the treatment.

The reactor (1) comprises three parts: a head (8), located in the upper part; a reaction chamber (9), located in intermediate position, that is, under the head, and a base (10), below the reaction chamber.

The head (8) has a conical shape and the torch or torches (6, 7), preferably at least two torches (6, 7), as well as the gas outlet (5), for example a nozzle, are mounted on it to discharge the gases generated in the reactor (1); and three feed inputs: solids inlet (2), liquid inlet (3) and gas inlet (4). Preferably, the head (8) does not have to end in a vertex, but it may be comprised of a truncated cone shape, with a larger lower base and a smaller upper base.

Preferably, two torches (6, 7) are incorporated, comprising a first torch (6) and a second torch (7), wherein the first torch (6) is a main torch, while the second torch (7) is an auxiliary torch that provides an additional heat capacity, both at start-up and at steady-state. In particular, the presence of the second torch (7) helps to facilitate the formation of lavas at the start-up, as well as to maintain in a stationary state the lavas in a liquid state, and with a reduced temperature gradient, without the need to oversize the first torch (6). In the example of the figures, a single second torch (7) has been represented, although there may be more than one second torch (7). It is preferred that the second torch or torches (7) are located opposite to the first torch (6). The first torch (6) and, where appropriate, also the second torch (7), are mounted on the head (8), preferably perpendicular to the conical surface. Preferably, the torches (6, 7) comprise free ends inside the reactor (1), which are separated by a horizontal distance between 45 cm and 55 cm, to avoid turbulence on contact with the plasma jets, and thus avoid damages between the two torches (6, 7) and to reduce the temperature gradient.

The conical (or truncated cone) shape of the head helps to provide adequate residence time for the wastes, for a minimum of 2 s, and it allows to house, at least partially, the torches (6, 7) in order to facilitate the dissociation of the waste. Additionally, it facilitates a faster discharge of the gases generated during the procedure. Likewise, it allows the waste to access the torches (6, 7) and the generated lavas with greater proximity. According to an exemplary embodiment, the head (8) has a coning angle (a) between 45° and 60°, preferably 50°.

On the other hand, the direction of the torches (6, 7) cooperates with the conical shape of the head (8), to house the torches (6, 7) and maintain the temperature of the lavas.

Likewise, the arrangement of the gas outlet (5) in the head (8) helps to quickly extract the gases due to the conical shape of the head (8).

The reaction chamber (9) has a hollow cylindrical shape, formed by a side wall (11) comprising a covering (12) of refractory material. Preferably, the refractory covering (12) comprises several zones (13, 14) of different materials. In particular, it preferably comprises two zones (13, 14): a first zone (13), more internal, for example of silicon carbide (SiC), inert to the temperature and composition of the lavas, to withstand high temperatures, so that they are not attacked by the lavas, that is, they do not mix with the lavas, they do not react with the lavas (corrosion, oxidation), nor do they degrade (do not melt) due to the heat of the lavas, and a second zone (14), more external, for example of high alumina, to avoid outward heat transmission.

On the other hand, the covering (12) preferably comprises a layer (15), or several layers (15) overlapped. In the figures, the case of several layers (15) is represented, in particular, three layers (15) overlapped. In particular, even more preferably, at least one of the zones (13, 14), preferably all the zones (13, 14) comprise in turn one or more layers (15) formed by blocks (32), preferably in a staggered manner to avoid leakage of lavas between joints and unwanted transfer of heat between joints. In the figures, two zones (13, 14) are shown, each of which is formed by two layers (15) of blocks (32). Preferably, an insulator (29) and an electrical and thermometer are also placed in a more external position.

The base (10) supports the weight of the head (8) and of the reaction chamber (9), as well as it may be preferably configured in reinforced concrete, for example reinforced with two rows of steel bars (not shown).

The base (10) further comprises an upper face (16), which serves as a background to the reaction chamber (9), to receive the lavas. The upper face (16) is preferably sunk, that is, it has a decreasing section, like an inverted dome, with a height of approximately 4 cm. Likewise, on the upper face (16), preferably in the center, a sump (17) is arranged to discharge the accumulated lavas, as explained below.

To prevent the accumulated lavas from reaching an excessive level, the side wall (11) is crossed, at a predetermined height above the upper face (16) of the base (10), by at least one drain hole (18), connectable to a pipe (not shown) that discharges the lavas from inside the reactor (1) to a location where they are available. To facilitate the discharge, it is possible to have a small container (30) laterally attached to the reaction chamber (9), where the drain hole (18) disgorges, and which bottom is connected to the pipe. According to a preferred example, the hole or drain holes (18) are located to prevent accumulation of more than 0.4 m³ of lavas in the reaction chamber (9). Preferably, the hole or drain holes (18) are located at an elevation located near the upper part of the reaction chamber (9) and, for example, approximately at the height of the third row of refractory covering (12) from bottom to top.

In its lower part, the base (10) comprises a diametrical through-groove (19), comprising side walls (20) and a roof (21), where the sump (17) disgorges through the roof (21).

The groove (19) serves to allow a manifold (22) to enter at one end, and exit, if necessary, at the opposite end, the collector (22) being in operation, located under the sump (17), for collect the lavas. Before being in the groove, the collector (22) is preferably preheated up to a predetermined working temperature, depending on the working conditions, to avoid subjecting the lavas to temperature contrasts that would solidify them. To support both the weight and the high temperatures of the lavas, the collector (22) is preferably made of steel coated with refractory cement.

To discharge the lavas as they are formed, and thus prevent them from accumulating inside the reactor (1), the reaction chamber (9) incorporates various solutions related to discharge means to discharge the lava, which have already been mentioned in previous paragraphs, and which are explained in more detail below. A first solution refers to the aforementioned hole or drain holes (18) of the side wall (11). A second solution refers to the sump (17) mentioned above. Preferably, the sump (17) is blocked by default by a first operable plug (31). For example, a slot (23) made in the upper face (16) of the base (10), and which disgorges into the side wall (11), allows access from the outside of the reaction chamber (9) to the first plug (31). The slot (23) is preferably oblique, since it is made in the upper face (16) which, as indicated above, is preferably domed.

Preferably, the sump (17) is blocked by default, for example, with the first plug (31). As the lavas accumulate, they reach the level of the hole or the drain holes (18) and are therefore discharged through the hole or the drain holes (18). As an emergency solution, either alternative or secondary to the two aforementioned solutions, the first plug (31) may be removed and then the lavas are discharged by the sump (17) towards the collector (22). The collector (22) may, in turn, include a second plug (24) to discharge the lavas towards a place where they are available, although it may also be movable. Preferably, from the upper part of the base (10) a flange (25) is extended upwards, which main effect is to provide a greater anti-spill safety for lavas, since it slightly protrudes from the slot (23). According to a preferred example, the flange (25) has a height of about 5 cm in relation to the upper face (16).

As indicated above, the feed inputs (2, 3, 4) comprise: a solid inlet (2), a liquid inlet (3) and a gas inlet (5). They are described in more detail below.

The solid hazardous waste, once pretreated, for example to fit its size to predetermined ranges, access to a feeding system comprising a hopper (not shown) and means for feeding solids (26), for example, an endless screw driven by a geared motor (24), from where they are introduced in the head (8) through the solids inlet (2), with a direction preferably parallel to that of the first torch (6) and, consequently that of the plasma jet—and an inlet rate that is appropriate for the solid waste to reach the intermediate zone of the plasma jet. The means for feeding solids (26), for example, the endless screw, are separated from the first torch (6) by a distance, measured vertically, which prevents them from being damaged by temperature, said distance may be for example 25 cm. The means for feeding solids (26) may be coated with graphite. Thus, a complete dissociation of the molecules from the solid waste is allowed. Preferably, the endless screw may incorporate a slide made of graphite. Preferably, the solid waste is fit to a size between 1 cm and 5 cm, which allows the solid waste to be dissociated adequately without the need to invest in fitting to a smaller size. The means for feeding solids (26) may preferably incorporate a conical nozzle, at the end of the endless screw, in the area of the solids inlet (2).

On the other hand, liquid hazardous wastes are fed from a liquid tank (not shown) using means for feeding liquids, such as a variable pressure motor pump through a liquid pipe (27), for example, AISI 304 of 1″ (2.54 cm) in diameter, parallel to the first torch (6), and optionally provided with an exit angle of between 40° and 50° in relation to the first torch (6), towards said first torch (6), which allows the liquid waste to reach the plasma jet, preferably its intermediate zone, in less than a second, without colliding with other wastes. The liquid pipe (27) protrudes from the head (8), entering into the reaction chamber (9), for example, in a length of about 11 cm. Preferably, the liquid pipe (27) provides droplets between 0.1 and 0.2 mm in diameter.

Likewise, gaseous hazardous wastes are stored in a gas tank (not shown) and from there they are introduced using means for feeding gases, such as a variable pressure pump (not shown), through a gas pipe (28), for example AISI 304 of 1″ (2.54 cm) in diameter, preferably parallel to the first torch (6), and which is also provided with an exit angle, between 40° and 50° with the first torch (6), directed towards said first torch (6), which allows the gaseous waste to reach the plasma jet, preferably its intermediate zone, in less than a second, without colliding with other wastes. The gas pipe (28) protrudes from the head (8), entering into the reaction chamber (9), for example over a length of about 11 cm. Preferably the gas pipe (28) supplies drops of liquefied gas between 0.033 and 0.05 mm in diameter, since the gas is liquefied in the gas pipe (28).

Preferably, for safety reasons, the gas outlet (5) incorporates safety elements (not shown) to control the gas flow expelled based on pressure, such as overpressure valves and various sensors, for example, flow meters, manometers, etc. (not shown).

The apparatus of the invention allows operating simultaneously (although they are fed by independent means) with hazardous waste in the three phases: solid, liquid or gaseous, by means of directed feeds that avoid collision between the wastes.

According to a preferred illustrative example, an apparatus for treating hazardous waste is described below, comprising a reactor (1), wherein the reactor has a head (8) located in the upper part having a truncated cone shape, with a height of 62 cm, a larger lower base having a diameter of 160 cm, a smaller upper base having a diameter of 13 cm, and a wall thickness of 22 cm. The head (8) thus described has a generatrix inclination angle of 50° in relation to the horizontal, that is to say, with a cone half-angle of 40°.

In the head (8) two plasma torches (6, 7) are mounted, comprising a first torch (6), with a power up to 150 kW, which generates plasma jets up to 500 mm in length, and a second torch (7), with a power between 120 and 150 kW. The torches (6, 7) are mounted perpendicular, that is, oriented at 40° in relation to the horizontal.

Each plasma jet has several portions, with decreasing temperatures when farther away from its torch (6, 7). For example, the farthest end of the jet, called the tip, may have a temperature of about 1000° C. An ideal zone to cause complete dissociation of the waste is approximately located in the central part of the jet, with a temperature of 3500-4000° C.

The reactor (1) in turn comprises a reaction chamber (9), located under the head (8), which has a cylindrical shape, and wherein the plasma jets of the torches (6, 7) dissociate the components of hazardous waste. The reaction chamber (9) has an outer diameter of 170 cm, an inner diameter between 78 cm and 88 cm and a height of 71 cm, and internally it is covered with a refractory covering (12) in several zones (13, 14). The torches (6, 7) protrude from the head (8) and enter into the reaction chamber (9) at a distance of 11 cm.

The reactor (1) also incorporates a base (10), located under the reaction chamber (9), and that supports the weight of the head (8) and the reaction chamber (9), besides being configured to help discharge the lavas, as described above. The base (10) may preferably be made of reinforced concrete, for example with two rows of reinforced steel bars. According to the example described above, it has a cylindrical shape with a uniform diameter of 180 cm, height of 60 cm, wherein the groove (19) has a width of 60 cm and a height of 45 cm, in accordance with the dimensions of the collector (22).

The reactor (1) described in the example allows to handle up to 5 t/day of waste, and it is movable, in particular containerizable.

1. An apparatus for treating hazardous waste, the apparatus comprising a pyrolytic plasma reactor that includes:
a head having a conical shape with a cone half-angle of 40°, a first torch and a second torch being mounted to the head:
separate inlets for solid, liquid and gaseous hazardous wastes;
wherein a solid feeder feeds solid waste through the solids inlet, and which in turn incorporate:
a endless screw; and
a conical nozzle to direct the solid waste to be treated;
wherein the endless screw is parallel to the first torch.
wherein the liquid pipe is parallel to the first torch, to feed the liquid hazardous waste through the liquid inlet, is configured to supply drops between 0.1 and 0.2 mm in diameter; and
wherein the gas pipe is parallel to the first torch, to feed the liquid hazardous waste through the gas inlet, is configured to supply drops of liquefied gas between 0.033 and 0.05 mm in diameter; and
the first torch generates a plasma jet to dissociate the waste;
the second torch maintains a temperature of 1000° C. in the reaction chamber;
a gas outlet fitted with an overpressure valve, a manometers and a flow meter, to discharge such gases generated by the dissociation;
the reaction chamber, located under the head, which has hollow cylindrical shape and incorporates a side wall with a refractory covering;
a base for supporting the head and the reaction chamber, the base having an upper face which has an inverted dome shape and serves as a background to the reaction chamber, to receive lavas formed in the dissociation; and
a lava discharge located in the reaction chamber or in the base, wherein the discharge are the following ones:
a diametrical through-groove, in the lower part of the base, and comprising side walls and roof; and
a sump, located on the upper face of the reaction chamber, and which disgorges into the groove.

2. The apparatus for treating hazardous waste according to claim 1, wherein the discharge comprise one drain hole, which passes through the side wall of the reaction chamber above the upper face.

3. The apparatus for treating hazardous waste according to claim 2, wherein it also incorporates a collector, housed in the groove of the base, below the sump, to collect the lavas.

4. The apparatus for treating hazardous waste according to claim 2, wherein the discharge further comprise:
a first plug for blocking the sump, and
a slot, made in the upper face of the base, and which disgorges into the side wall of the reaction chamber, to allow access to the first plug.

5. The apparatus for treating hazardous waste according to claim 1, wherein it further comprises a flange extending upwards from the upper part of the base, protruding from the groove.

6. The apparatus for treating hazardous waste according to claim 1, wherein the refractory covering comprises blocks distributed in:
a first zone of silicon carbide, more internal, inert to the temperature and composition of the lavas; and
a second zone, more external, of high alumina, to avoid outward heat transmission.

7. The apparatus for treating hazardous waste according to claim 6, wherein it further comprises an insulator made of rock wool and located on the side wall of the reaction chamber.

8. The apparatus for treating hazardous waste according to claim 6, wherein the first zone and/or the second zone comprise three layers of blocks.

9. The apparatus for treating hazardous waste according to claim 8, wherein the layers of one of the zones having more than one layer are staggered.

10. The apparatus for treating hazardous waste according to claim 1, wherein the head has a coning angle (a) between 45° and 60°.

11. The apparatus for treating hazardous waste according to claim 1, wherein the second torch is mounted on the head, opposite to the first torch.

12. The apparatus for treating hazardous waste according to claim 11, wherein the first torch and the second torch are mounted perpendicular to the head.

13. The apparatus for treating hazardous waste according to claim 11, wherein the first and second torches comprise free ends, inside the reactor, which are separated horizontally by a distance between 45 cm and 55 cm.

14. The apparatus for treating hazardous waste according to claim 1, wherein the gas pipe and the liquid pipe form an exit angle between 40° and 50° in relation to the first torch, directed towards the first torch.

15. The apparatus for treating hazardous waste according to claim 1, wherein the liquid pipe and the gas pie protrude from the head, entering into the chamber reaction.

16. A method for treating hazardous waste using the apparatus for treating hazardous waste of claim 1, wherein the method comprises the following steps:
keeping the first torch lit by maintaining a temperature of 1000° C. in the reaction chamber;
directing the hazardous solid, liquid and gaseous waste towards the central part of the plasma jet, having a temperature between 3500° C. and 4000° C. and released simultaneously by the first torch, without having any contact between the solid, liquid and gaseous waste.

17. The method for treating hazardous waste according to claim 16, wherein it comprises an additional step of keeping the second torch lit to help in the formation of lavas at the start-up of the dissociation, as well as to maintain the lavas in liquid state.

18. The method for treating hazardous waste according to claim 16, wherein it comprises a further step of keeping the sump selectively blocked or unlocked to allow the lavas to be discharged by the hole or drain holes, or also by the sump, respectively.

19. The method for treating hazardous waste according to claim 18, wherein it comprises a further step of arranging the collector in the groove to receive the lavas from the sump.

20. The method for treating hazardous waste according to claim 19, wherein it comprises a further stage of preheating the collector wherein the temperature range used is from 900° C. to 1000° C. during 4 to 5 hours.
